(19) United States
(12) Patent Application Publication
(10) Pub. No.: US 2009/0102277 A1
(43) Pub. Date: Apr. 23, 2009

(54) Automatic Brake Control Device

(76) Inventors: Toshiki Ezoe, Tokyo (JP); Shuji Narada, Tokyo (JP); Naoshi Ichinose, Tokyo (JP); Koichi Okamoto, Tokyo (JP); Hirokazu Okuyama, Tokyo (JP)

Correspondence Address: VON SIMSON & CHIN, 62 WILLIAM STREET, 6TH FLOOR, NEW YORK, NY, 10005, US

(21) Appl. No.: 12/064,609

(22) PCT Filed: Aug. 8, 2006
(86) PCT No.: PCT/JP2006/315646

§ 371 Date: Feb. 22, 2008

(30) Foreign Application Priority Data
Aug. 24, 2005 (JP) 2005-242053
Aug. 24, 2005 (JP) 2005-242066
Aug. 24, 2005 (JP) 2005-242068
Aug. 24, 2005 (JP) 2005-242078

(51) Int. Cl. B60T 7/12; B60T 8/86

(52) U.S. Cl. 303/22.1; 303/125

(57) ABSTRACT

A stepwise brake control is automatically performed when TTC obtained according to a relative distance and a relative speed between a vehicle and an object is lower than a predetermined value. For example, a brake pattern is modified according to the weight of a cargo and passengers. Alternatively, a driver selects a brake pattern of different (rapid or slow) speed reduction according to the type or weight of the passengers and cargo. Furthermore, the driver's psychology is acquired according to the alarm distance between vehicles set by the driver and an optimal brake pattern is selected according to this. Alternatively, an operation state of the vehicle by the driver is detected and if the detection result does not satisfy a predetermined condition, the set value of the TTC is increased. For example, the predetermined condition indicates the normal state of the driving by the driver. Alternatively, when the condition indicating the normality of driving by the driver is satisfied, the number of stages is reduced. Furthermore, brake control is adaptively performed according to the time required until collision.

### TECHNICAL FIELD

The present invention is utilized for a heavy vehicle (truck, bus) for transporting cargos and passengers.

### BACKGROUND ART

An electronic control tendency of an automobile gets ahead quickly, and an event which previously depended upon a driver's judgment is also controlled by a computer loaded on a vehicle.

As one example, there is an automatic brake control device in which a distance between a subject vehicle and a vehicle ahead (distance between the vehicles) is monitored by a radar, and when the distance between the vehicles becomes abnormally short, brake control is performed automatically, and when collision occurs, damage is suppressed to a small level (see patent document 1 for example).

Patent Document 1: JP2005-31967A

### DISCLOSURE OF THE INVENTION

### Problem to be Solved by the Invention

That is, the heavy vehicle has extremely large mass as compared with a passenger vehicle, it is necessary to secure safety for the passengers or cargos in addition to safety for a driver himself or herself, it is difficult to achieve the intended purpose only by simple abrupt brake control which is carried out in an automatic brake control of a passenger vehicle, and it is necessary to perform more precise automatic brake control as compared with the passenger vehicle. However, since such means is not established, an automatic brake control device for a truck or a bus has not yet become commercially practical.

The present invention has been accomplished under such background, and it is an object of the invention to provide an automatic brake control device capable of realizing the automatic brake control in a truck and a bus.

### Means for Solving the Problems

The present invention provides an automatic brake control device including control means which automatically performs brake control based on a sensor output including a distance between a subject vehicle and an object existing ahead the subject vehicle even if there is no driving operation, the control means including a stepwise brake control means which automatically performs stepwise brake control when an estimated value of a time elapsed until a distance between the object and the subject vehicle derived based on a relative distance and a relative speed between the object and the subject vehicle obtained by the sensor output becomes equal to or smaller than a predetermined value.

The estimated value of time elapsed until a distance between the object and the subject vehicle computed based on a relative distance and a relative speed between the object and the subject vehicle refers to for example, an estimated value of time elapsed until for example, an object and a subject vehicle collide (hereinafter referred to as TTC (Time To Collision).

The feature of the present invention exists in that the stepwise brake control means contains a means for changing the braking pattern corresponding to the weight of loaded cargo or passengers.

By increasing the braking force or the brake decelerating speed gradually step by step without using a maximum braking force suddenly, a braking pattern near the braking pattern which a truck and bus driver usually executes can be achieved. Consequently, the vehicle speed can be decreased with the vehicle safety maintained. At this time, the automatic brake control can be executed appropriately in a truck and bus whose braking characteristic changes corresponding to the weight of loaded cargo and passengers.

Alternatively, different plural braking patterns for executing the stepwise brake control may be provided and the stepwise brake control means may include a means for selecting any of the plural braking patterns corresponding to an operation input. Consequently, by preparing plural braking patterns for executing the stepwise brake control, the vehicle driver can select a braking pattern regardless of the weight of loaded cargo or passengers.

Consequently, the vehicle driver can select a braking pattern corresponding to the type and weight of passengers or cargo. For example, if many aged persons or infants are included in passengers or the cargo is precision machine or artifact, a braking pattern which provides a relatively mild deceleration may be selected. Further, by selecting a braking pattern which provides a relatively mild deceleration as compared with a case where the weight is small, in case where the weight of passengers or cargo is large, the safety of the vehicle can be maintained high.

For example, the integration values of the different plural braking patterns may be equal while the braking force or brake decelerating speed on a final stage of each braking pattern may be different. Consequently, an arbitrary braking pattern can be selected corresponding to the degree of urgency of deceleration.

The braking pattern may contain a pattern of notifying a vehicle driver of an alarm instead of the brake control on other stages than the final stage in the stepwise brake control.

This braking pattern is a braking pattern which urges the vehicle driver to pay attention and is premised that the urged vehicle driver drives his or her vehicle for himself or herself and is based on a concept that the automatic brake control is an auxiliary means for the drive operation by the vehicle driver himself or herself. Including the braking pattern based on such a concept in plural choices of the braking patterns is effective for intensifying the freedom of selection of the braking patterns.

An inter-vehicular distance alarm means for dispatching an alarm corresponding to an inter-vehicular distance between a leading vehicle traveling in front and a subject vehicle may be further included and the inter-vehicular distance alarm means may be equipped with a means for setting the inter-vehicular distance which dispatches the alarm by operation of the vehicle driver while the operation input is interlocked with setting operation of the setting means.

That is, if analyzing psychological state of a vehicle driver who wants to set the length of the inter-vehicular distance which makes the inter-vehicular distance alarm means to dispatch an alarm short, it represents that dependence on the inter-vehicular distance alarm means of the vehicle driver is low. On the contrary, if analyzing the psychological state of the vehicle driver who wants to set the length of the inter-vehicular distance which makes the inter-vehicular distance alarm means to dispatch the alarm longer, it represents that dependence on the inter-vehicular distance alarm means of the vehicle driver is high.

Thus, high or low dependence on the inter-vehicular distance alarm means of the vehicle driver is reflected on selecting the braking pattern in the automatic brake control and if the dependence is high, a braking pattern which is started up early is selected. On the contrary, if dependence thereon is low, a braking pattern which takes driving operation by the driver himself or herself as preference is selected.

The braking pattern which takes the driving operation by the driver as preference is, for example, a braking pattern containing a pattern of notifying the driver of an alarm instead of executing the brake control on other stages than the final stage in the above-described stepwise brake control.

Further, a means for detecting an operation execution condition to the vehicle by the vehicle driver and a means for raising the set value unless the result of detection by the detecting means satisfies a condition indicating normality of operation by the vehicle driver may be further provided.

That is, if it can be estimated that the vehicle driver does not execute normal operation for the reason of drowsy driving or inattentive driving, the timing of starting the automatic brake control is hastened so as to intensify the effect of the automatic brake control device.

Although the automatic brake control device of the present invention is premised on a condition in which no braking operation is performed due to drowsy driving or inattentive driving of the driver, the device of the present invention may be applied even under a condition in which the vehicle driver is braking so as to support the brake operation of the driver thereby reducing a disaster due to collision.

That is, as described above, a means for detecting an operation execution condition to the vehicle by the vehicle driver and a means for reducing the quantity of stages if the result of detection by the detecting means satisfies normality of operation by the vehicle driver are further provided.

Consequently, different automatic brake control can be executed between under a situation in which the vehicle driver is driving in sleepy condition or inattentively and under a situation in which the vehicle driver is driving normally and executing collision avoidance operation until just before a collision. Thus, even if the vehicle driver is performing the collision avoidance operation, the automatic brake control of the device of the present invention can be used effectively.

The reducing means may include a means for starting the automatic brake control from the final stage of the plural stages. That is, because no stepwise brake control is needed any more if the vehicle driver is performing the collision avoidance operation, the device of the present invention may start the brake control from its final stage.

The brake control means can include a means for changing the braking pattern corresponding to the estimated value.

That is, if the TTC can be computed as a time having allowance in a condition in which a distance to an object is sufficient, the brake control which increases the braking force gradually through plural stages may be executed as planned initially. Consequently, brake control suitable for a heavy vehicle such as truck and bus can be performed.

However, if any object appears in front of a vehicle suddenly or the radar for measuring a distance to a leading vehicle traveling in front cannot detect due to its special shape until just before or the radar loses the leading vehicle because it travels eccentrically on the right or left side not in the center of a lane and after that, that vehicle is detected again just in front of the leading vehicle, the TTC may be much a shorter time than planned initially.

The present invention can meet such a situation appropriately. The means for changing the braking pattern includes a means for reducing the quantity of stages of the brake control planned initially corresponding to the TTC and can meet any TTC.

The means for reducing the quantity of the stages can contain a means for changing the shape of a braking pattern applied if the quantity of the stages is not reduced to the shape of a new braking pattern corresponding to the reduced quantity of the stages.

Consequently, further effective brake control can be achieved as compared with a case of reducing the quantity of stages.

The means for changing the braking pattern can contain a means for changing the shape of the braking pattern without reducing the quantity of the stages. Consequently, a sudden change of the braking pattern can be avoided thereby maintaining the stability of the vehicle high.

A means for if the speed of a subject vehicle is less than a predetermined value and the steering angle or the yaw rate is out of a predetermined range, prohibiting startup of the stepwise brake control means may be further provided.

That is, the stepwise brake control performed by the automatic brake control device of the present invention is presumed for use in conditions that the vehicle speed of the subject vehicle before the brake control is started is 60 km/h or more and no such large steering operation as during changing a traveling lane or during traveling on a steep curve is being executed and thus, in other traveling conditions, the startup of the stepwise brake control can be limited.

For, example, if the vehicle speed of the subject vehicle before the brake control is started is less than 60 km/h, kinetic energy possessed by the vehicle is small and therefore, no trouble occurs even if simple quick brake control which has been applied to a passenger vehicle conventionally is carried out, thereby limiting the startup of the stepwise brake control. Further, if the steering angle before the brake control is started is +30 degrees or more or −30 degrees or less, this means that the vehicle is changing its lane or traveling on a steep curve, and thus, this is out of a scope in which the stepwise brake control is applicable thereby limiting the startup of the stepwise brake control. In this case, the yaw rate may be used instead of the steering angle.

### EFFECT OF THE INVENTION

The present invention can realize the automatic brake control in a truck and bus. Particularly, appropriate automatic brake control can be carried out corresponding to changes in weight of loaded cargo and passengers. Alternatively, because arbitrary braking pattern can be selected corresponding to the urgency of deceleration, automatic brake control suitable for the type and weight of passengers or cargo can be achieved.

Further, a braking pattern suitable for the psychological state of a vehicle driver can be selected. Alternatively, an appropriate automatic brake control can be performed corresponding to an operating condition of the vehicle driver.

Further, even if the TTC is extremely short, appropriate brake control can be executed.

### BRIEF DESCRIPTION OF THE DRAWINGS

FIG. 1 is a configuration diagram of control system according to a first embodiment.

FIG. 2 is a flow chart showing an operation of the brake control ECU of the first embodiment.

FIG. 3 is a diagram showing a braking pattern at the time of no load possessed by the brake control ECU of the first embodiment.

FIG. 4 is a diagram showing a braking pattern at the time of half load possessed by the brake control ECU of the first embodiment.

FIG. 5 is a diagram showing a braking pattern at the time of specified load possessed by the brake control ECU of the first embodiment.

FIG. 6 is a diagram showing a full-scale braking pattern possessed by the brake control ECU of the first embodiment.

FIG. 7 is a configuration diagram of control system according to a second embodiment.

FIG. 8 is a diagram which compares a first braking pattern with a second braking pattern in the second embodiment.

FIG. 9 is a diagram showing a second braking pattern at the time of no load possessed by the brake control ECU of the second embodiment.

FIG. 10 is a configuration diagram of control system according to a third embodiment.

FIG. 11 is a diagram which compares the first braking pattern with the third braking pattern in the third embodiment.

FIG. 12 is a flow chart showing a braking pattern selection procedure in the brake control ECU of the third embodiment.

FIG. 13 is a configuration diagram of control system according to a fourth embodiment.

FIG. 14 is a flow chart showing a braking pattern selection procedure in the brake control ECU 4 of the fourth embodiment.

FIG. 15 is a configuration diagram of control system according to a fifth embodiment.

FIG. 16 is a flow chart showing an operation of the brake control ECU of the fifth embodiment.

FIG. 17 is a diagram showing a braking pattern at the time of no load possessed by the brake control ECU of the fifth embodiment.

FIG. 18 is a diagram showing a braking pattern at the time of half load possessed by the brake control ECU of the fifth embodiment.

FIG. 19 is a diagram showing a braking pattern at the time of specified load possessed by the brake control ECU of the fifth embodiment.

FIG. 20 is a flow chart showing an operation of the brake control ECU of the sixth embodiment.

FIG. 21 is a flow chart showing an operation of the brake control ECU of the sixth embodiment.

FIG. 22 is a flow chart showing the operation procedure of the braking pattern at the time of no load according to a seventh embodiment.

FIG. 23 is a diagram for explaining a braking pattern #1 of the seventh embodiment.

FIG. 24 is a diagram for explaining a braking pattern #2 of the seventh embodiment.

FIG. 25 is a diagram for explaining a braking pattern #3 of the seventh embodiment.

FIG. 26 is a diagram for explaining a braking pattern #4 of the seventh embodiment.

### DESCRIPTION OF REFERENCE NUMERALS

1: millimeter-wave radar
2: steering sensor
3: yaw rate sensor
4: brake control ECU
5: gateway ECU
6: meter ECU
7: vehicle CAN
8: engine ECU
9: axial load scale
10: EBS_ECU
11: brake actuator
12: engine
13: vehicle speed sensor
14: brake pattern selecting change-over switch
16: auto cruise function change-over switch
17: inter-vehicular distance alarm portion
18: auto cruise ECU
19: accelerator pedal sensor
20: direction indicator switch sensor
21: accessory switch sensor
40: brake pattern selecting portion
41: brake pattern storing portion
60: normal operation detecting portion

### BEST MODE FOR CARRYING OUT THE INVENTION

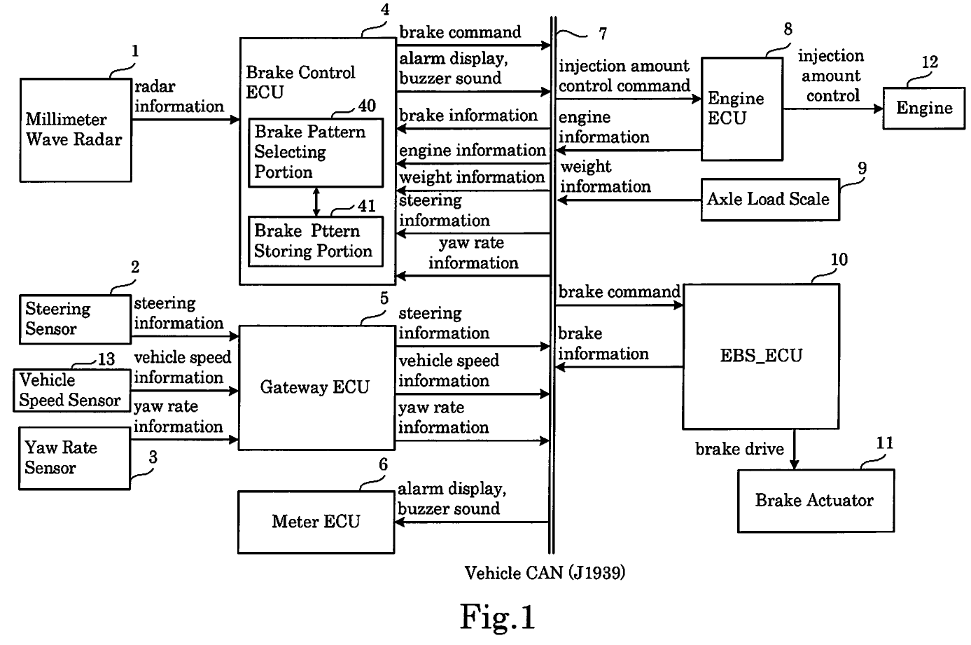

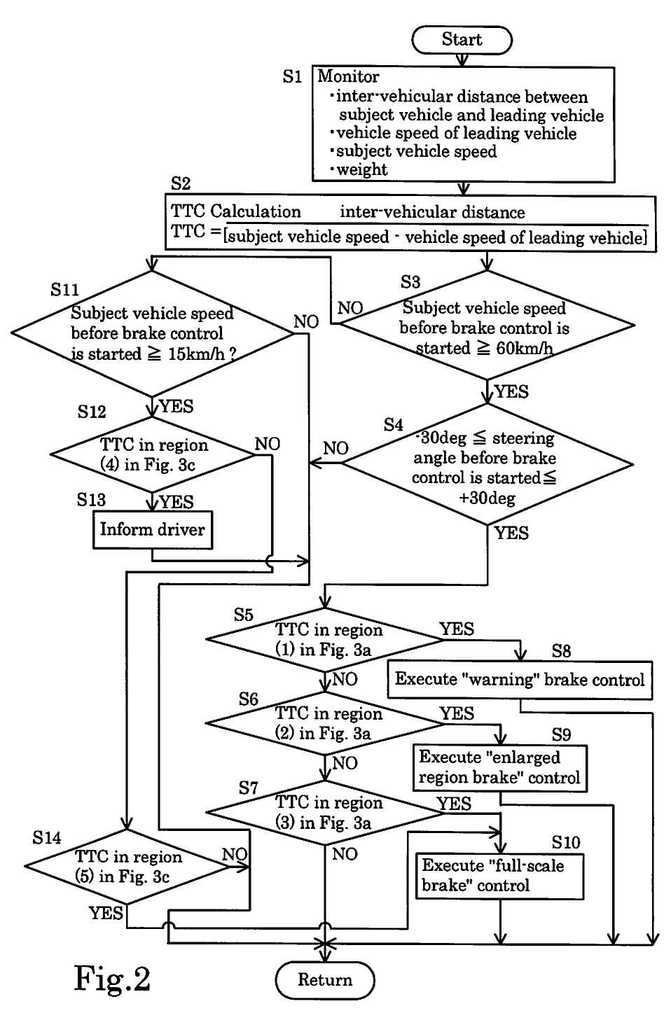

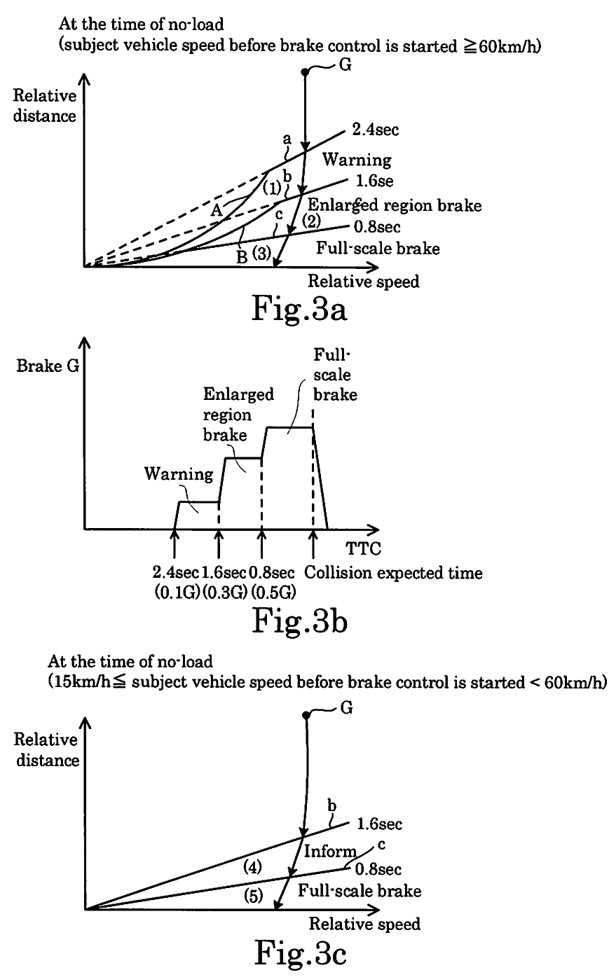

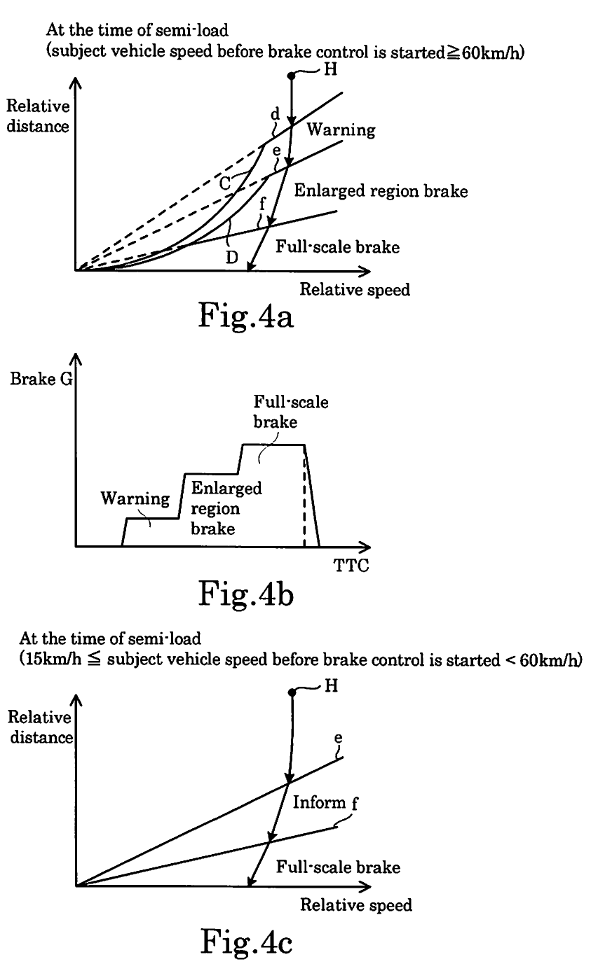

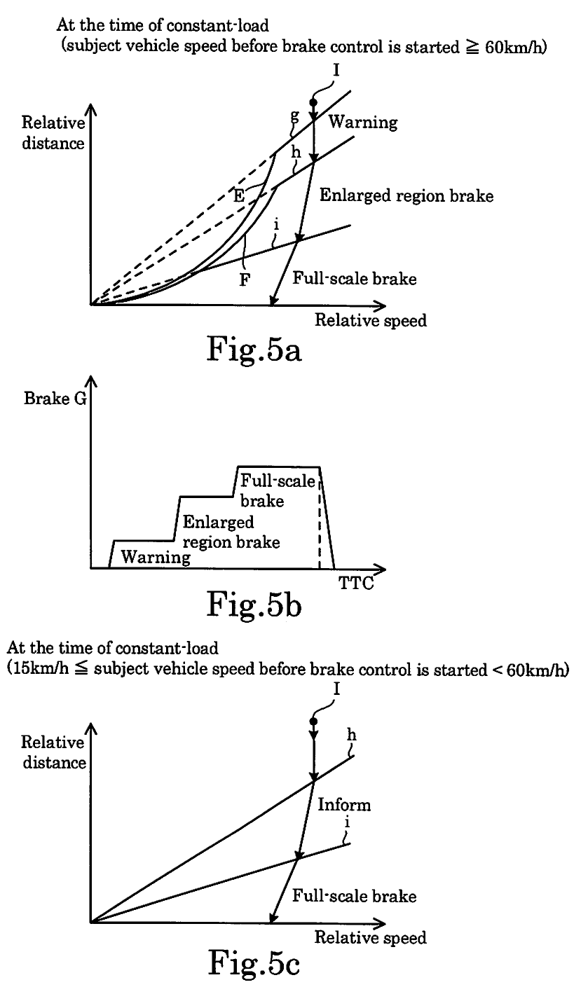

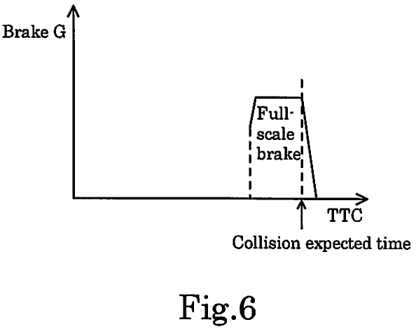

The automatic brake control device of the first embodiment will be described with reference to FIGS. 1 to 6. FIG. 1 is a configuration diagram of the brake control system of this embodiment. FIG. 2 is a flow chart showing the operation of the brake control ECU (Electric Control Unit) of this embodiment. FIG. 3 are diagrams showing the braking patterns at the time of no load possessed by the brake control ECU of this embodiment. FIG. 4 are diagrams showing the braking patterns at the time of half load possessed by the brake control ECU of this embodiment. FIG. 5 are diagrams showing the braking patterns at the time of specified load possessed by the brake control ECU of this embodiment. FIG. 6 is a diagram showing a full-scale braking pattern possessed by the brake control ECU of this embodiment.

As shown in FIG. 1, a brake control ECU 4, a gateway ECU 5, a meter ECU 6, an engine ECU 8, an axial load scale 9, and EBS (Electric Breaking System)_ECU 10 are connected through vehicle CAN (J1939) 7, respectively.

A steering sensor 2, a yaw rate sensor 3, and a vehicle speed sensor 13 are connected to the vehicle CAN (J1939) 7, respectively, through a gateway ECU 5 and these sensor information pieces are fetched into the brake control ECU 4. The brake control is carried out by EBS_ECU 10's driving the brake actuator 11. In the meantime, instruction on braking to the EBS_ECU 10 is carried out by brake operation in driver's seat (not shown) and the brake control ECU 4. Brake information containing information on brake operation by a vehicle driver is output by the EBS_ECU 10 and fetched into the brake control ECU 4. The engine ECU 8 executes fuel injection amount control of the engine 12 and other engine controls. In the meantime, instruction on the injection amount control to the engine ECU 8 is carried out by accelerator operation on the vehicle driver's seat. An alarm indication and buzzer sound output from the brake control ECU 4 are displayed on a display portion (not shown) of the vehicle driver's seat by the meter ECU 6. Representation of the control system relating to steering except the steering sensor 2 is omitted because it is not related directly to the present invention.

As shown in FIG. 1, this embodiment includes a brake control ECU 4 which automatically execute brake control even if no driving operation is performed based on outputs of sensors such as a millimeter-wave radar 1 for measuring a distance to an object such as a leading vehicle traveling in front of a subject vehicle or fallen object, a steering sensor 2 for detecting a steering angle, a yaw rate sensor 3 for detecting a yaw rate, and a vehicle speed sensor 13 for detecting the vehicle speed. The brake control ECU 4 is an automatic brake control device equipped with a stepwise brake control means which automatically performs brake control step by step when TTC introduced based on a relative distance and a relative speed between the object and the subject vehicle obtained by sensor output from the millimeter-wave radar 1 and the vehicle speed sensor 13 drops below a set value.

As shown in FIG. 3 to FIG. 5, the stepwise brake control means contains a brake control means which increases a brake force gradually through three steps in time series. In an example of FIG. 3b, a brake of about 0.1 G is applied from TTC 2.4 seconds up to 1.6 seconds on a first stage described as “warning”. On this stage, so-called quick brake has not been yet applied and a stop lamp is lit so as to notify a vehicle traveling in the back that the quick brake will be carried out soon. Next, on a second stage described as “enlarged region brake”, a brake of about 0.3 G is applied from TTC 1.6 seconds up to 0.8 seconds. Finally, on a third stage described as “full-scale brake”, a maximum brake (about 0.5 G) is applied from TTC 0.8 seconds up to 0 second.

In the meantime, if a vehicle driver performs a stronger brake operation than the above-described brake force, that stronger brake force is applied with a preference.

According to this embodiment, as shown in FIGS. 3 to 5, the brake control ECU 4 is characterized in containing a brake pattern selecting portion 40 for changing the braking pattern corresponding to the weight of loaded cargo and passengers. As for the changing method, with plural control patterns at the time of no load, half load and specified load memorized in the brake pattern storing portion 41 of the brake control ECU 4, the brake pattern selecting portion 40 selects a brake pattern appropriate (or similar) from these braking patterns corresponding to the weight. The weight information of the loaded cargo and passengers is obtained by the axial load scale 9 shown in FIG. 1 and fetched into the brake control ECU 4.

Although the leading vehicle will be described in a following description, the automatic brake control device of this embodiment is effective to a fallen object on a road.

Further, a means for prohibiting the stepwise brake control means from being started up when the vehicle speed is less than 60 km/h while the steering angle is +30 degrees or more or −30 degrees or less is included. In the meantime, the yaw rate may be used instead of the steering angle.

That is, the stepwise brake control performed by the automatic brake control device of this embodiment is presumed for use in conditions that the vehicle speed of the subject vehicle before the brake control is started is 60 km/h or more and no such large steering operation as during changing a traveling lane or during traveling on a steep curve is being executed and thus, in other traveling conditions, the start up of the stepwise brake control can be limited.

If the vehicle speed of the subject vehicle before the brake control is started is less than 60 km/h, kinetic energy possessed by the vehicle is small and therefore, no trouble occurs even if simple quick brake control which has been applied to a passenger vehicle conventionally is carried out and the validity of executing the stepwise brake control is low, thereby limiting the start up of the stepwise brake control. Further, if the steering angle before the brake control is started is +30 degrees or more or −30 degrees or less, this means that the vehicle is changing its lane or traveling on a steep curve, and thus, this is out of a scope in which the stepwise brake control is applicable thereby limiting the start up of the stepwise brake control. In this case, the yaw rate may be used instead of the steering angle.

According to this embodiment, if the vehicle speed of the subject vehicle is less than 60 km to 15 km/h (lowest speed under which the validity of the automatic brake control (only full-scale brake control) can be recognized) or more, only the full-scale brake control shown in FIG. 3b to FIG. 5b is carried out as shown in FIG. 6 although no stepwise brake control is performed. When such full-scale brake control only is performed, the same brake control as the conventional automatic brake control employed in a passenger vehicle can be applied. In the meantime, if the same automatic brake control as conventionally is applied, the step of determining whether or not the subject vehicle is changing its lane or traveling on a steep curve is not needed.

Next, the operation of the automatic brake control device of this embodiment will be described with reference to a flow chart shown in FIG. 2. Although FIG. 2 will be described about a braking pattern at the time of no load (FIG. 3), the procedure of the flow chart of FIG. 2 may be adopted at the time of half load (FIG. 4) or specified load (FIG. 5). As shown in FIG. 2, an inter-vehicular distance to a leading vehicle traveling in front and a vehicle speed of the leading vehicle are measured and monitored with the millimeter-wave radar 1. Further, the vehicle speed of the subject vehicle is measured and monitored by the vehicle speed sensor 13. The weight of loaded cargo and passengers is further measured and monitored by the axial load scale 9 (S1). The brake pattern selecting portion 40 of the brake control ECU 4 previously selects any braking pattern (FIG. 3 to FIG. 5) based on a result of measurement of the weight. A description below shows an example that the brake control pattern of FIG. 3 is selected.

TTC is computed according to the inter-vehicular distance, the speed of a subject vehicle and the speed of a leading vehicle traveling in front (S2). The computation method is by inter-vehicular distance/(subject vehicle speed−vehicle speed of the leading vehicle). If the speed of the subject vehicle before the brake control is started is 60 km/h or more and the steering angle before the brake control is started is +30 degrees or less and −30 degrees or more (S4) and TTC is in a range (1) shown in FIG. 3a (S5), the “warning” brake control is executed using an auxiliary brake 14 (S8). If TTC is a range (2) shown in FIG. 3a (S6), the “enlarged region brake” control is executed (S9). If TTC is a range (3) shown in FIG. 3a (S7), the “full-scale brake” control is executed (S10).

If the speed of a subject vehicle before the brake control is started is less than 60 km/h to 15 km/h or more (S3, S11) and TTC is a range (4) shown in FIG. 3c (S12), it is notified that the relative distance to the leading vehicle is small (S13). The notification is carried out by alarm display or buzzer sound. Further, if TTC is a range (5) shown in FIG. 3c (S14), the “full-scale brake” control is executed (S10).

In the meantime, the yaw rate from the yaw rate sensor 3 can be used instead of the steering angle from the steering sensor 2. Alternatively, the steering angle and the yaw rate may be used at the same time.

Here, FIG. 3 to FIG. 5 will be described. Straight lines c, f and i in FIG. 3 to FIG. 5 are called steering avoidance limit line. Curves B, D and F in FIG. 3 to FIG. 5 are called brake avoidance limit curve.

That is, the steering avoidance limit line is a straight line indicating a limit capable of avoiding a collision by steering operation within a predetermined TTC under a relative distance to an obstacle and a relative speed to the obstacle. The brake avoidance limit curve is a curve indicating a limit capable of avoiding a collision by brake operation within a predetermined TTC under a relative distance to the obstacle and a relative speed to the obstacle.

In an area in which both the straight line and the curve are concerned of an area below the straight lines or the curves in FIG. 3 to FIG. 5, a collision cannot be avoided any more by steering operation or by braking operation.

For example, in the example at the time of no load shown in FIG. 3, in a straight line c, TTC is set to 0.8 seconds. In this embodiment, above the steering avoidance limit line c, a straight line a in case where TTC is 2.4 seconds is provided and a straight line b in case where TTC is 1.6 seconds is provided. Further, a curve A in case where TTC is set to 1.6 seconds is provided above the brake avoidance limit curve B in which TTC is set to 0.8 seconds.

The state of the vehicle at that time has relative distance and a relative speed to an obstacle indicated with a black circle G in FIG. 3. When the speed of a subject vehicle before the brake control is started is 60 km/h or more, the relative distance decreases gradually and when it comes to a position on the straight line a, warning mode is generated (area (1)). Under the warning mode, brake of about 0.1 G is applied up to TTC 2.4 seconds to 1.6 seconds. This period is meaningful in lighting a stop lamp to notify a vehicle traveling in the back that the brake will be applied soon. When the relative speed decreases so that it comes to a position on the straight line b, the enlarged region brake mode is generated (area (2)). Under the enlarged region brake mode, brake of about 0.3 G is applied up to TTC 1.6 seconds to 0.8 seconds. When it comes to a position on the straight line c, the full-scale brake mode is generated (area (3)). Under the full-scale brake mode, maximum brake (about 0.5 G) is applied up to TTC 0.8 seconds to 0 second. According to computation of step S2 in FIG. 2, a collision occurs at this time. However, the speed of the subject vehicle is decreased by brake control, so that the actual TTC is longer than the computation result of step S2.

That is, computation of TTC on the automatic brake control device which the present invention handles is presumed to use a general purpose, simple distance measuring device (for example, millimeter-wave radar) or arithmetic operation device by omitting a precision distance measurement or complicated arithmetic operation if possible. This consideration is effective for suppressing manufacturing cost or maintenance cost of the vehicle.

Thus, strictly speaking, the TTC needs to be computed based on uniform accelerated motion because the leading vehicle which is an object and the subject vehicle are performing uniform accelerated motions by braking (decreasing the speed). However, by computing the TTC on an assumption that they are performing just uniform motions, the precision distance measurement and complicated arithmetic operation are omitted.

Although a computed TTC value is smaller than an actual TTC value by computation on the assumption that they are performing the uniform motions, this is an error to the safety side and there is no trouble if this is accepted.

When the speed of a subject vehicle before the brake control is started is 15 km/h or more to less than 60 km/h, the relative distance is decreased gradually and when a position on the straight line b is reached, notification mode is generated (area (4)). Under the notification mode, it is notified a vehicle driver that the relative distance to the obstacle is being decreased through alarm display or buzzer sound. When a position on the straight line c is reached, the full-scale brake mode is generated (area (5)). Under the full-scale brake mode, the maximum brake (about 0.5 G) is applied up to TTC 0.8 seconds to 0 second.

FIG. 4 show an example at the time of half load and FIG. 5 show an example at the time of specified load. If comparing under the same brake force, the brake distance is increased as the weight of loaded cargo and passengers are increased, so that the steering avoidance limit curve and brake avoidance limit curve move upward in the same Figure. Consequently, areas of the areas (1), (2), (3), (4) and (5) increase corresponding to the weight of the loaded cargo and passengers.

Straight lines a to c in FIG. 3 correspond to straight lines d-f in FIG. 4 and straight lines g to i in FIG. 5. Curves A and B in FIG. 3 correspond to curves C and D in FIG. 4 and curves E and F in FIG. 5. A black circle G in FIG. 3 corresponds to a black circle H in FIG. 4 and a black circle I in FIG. 5.

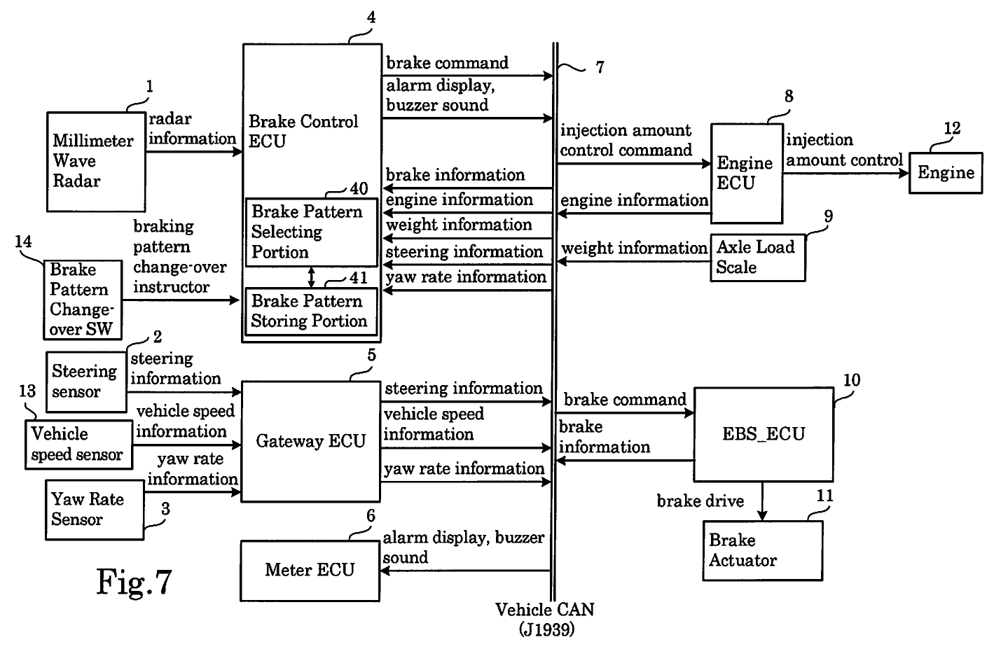

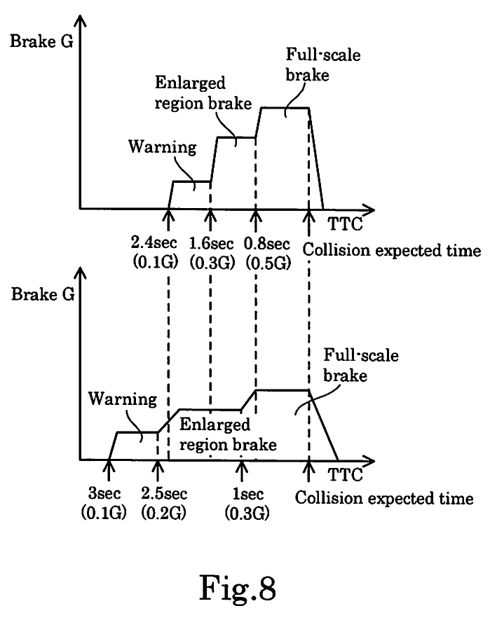

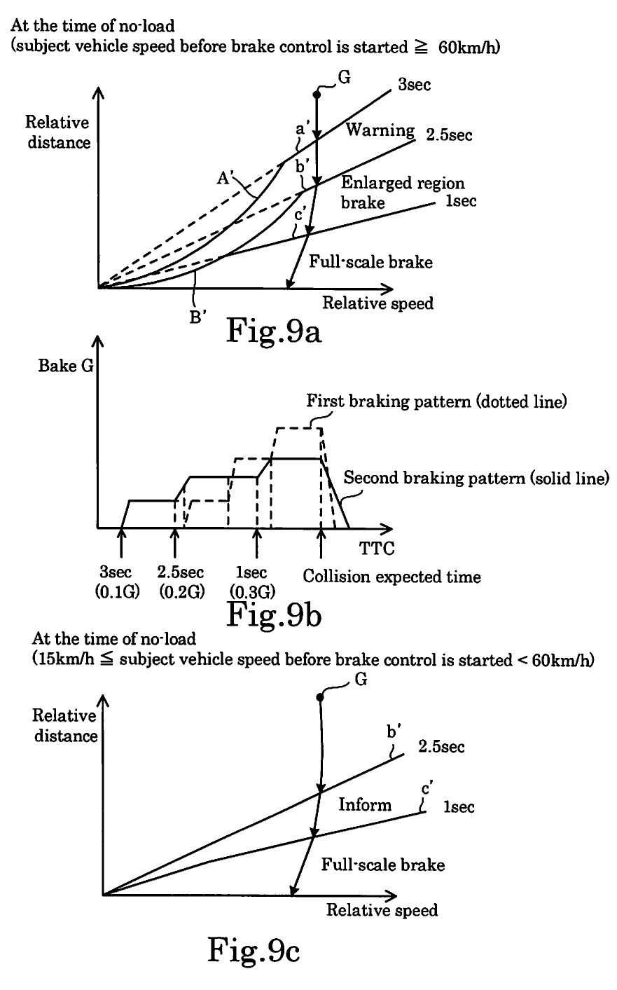

The automatic brake control device of the second embodiment will be described with reference to FIG. 7 to FIG. 9. FIG. 7 is a configuration diagram of the control system of this embodiment and FIG. 8 is a diagram for comparing different two brake patterns of this embodiment. FIG. 9 are diagrams showing a second braking pattern at the time of no load possessed by the brake control ECU of this embodiment.

The configuration of the control system of this embodiment shown in FIG. 7 is the configuration of the control system of the first embodiment shown in FIG. 1 plus a brake pattern change-over switch 14. Description of the configuration diagram of the control system of this embodiment, which is a duplicate of the first embodiment, is omitted.

As shown in FIG. 7, the brake control ECU 4, the gateway ECU 5, the meter ECU 6, the engine ECU 8, the axial load scale 9 and the EBS (Electric Breaking System)_ECU 10 are connected through the Vehicle CAN (J1939) 7. Further, the brake pattern change-over switch 14 is connected to the brake control ECU 4, which can give a braking pattern change-over instruction to the brake pattern selecting portion 40 so as to select a desired braking pattern from the plural braking patterns memorized in the brake pattern storing portion 41.

In this embodiment, different two braking patterns for executing the brake control step by step as well as the control patterns for “at the time of no load”, “at the time of half load” and “at the time of specified load” are memorized in the brake pattern storing portion 41 within the brake control ECU 4 as described in the first embodiment. The braking pattern shown in FIG. 3 to FIG. 6 of the first embodiment is called first braking pattern and the braking pattern shown in FIG. 9 is called second braking pattern. FIG. 9b represents the first braking pattern with a dotted line such that it overlaps the second braking pattern for comparison.

Although according to the braking patterns shown in FIG. 3 to FIG. 5, the startup timing of each stage is different, according to the braking pattern shown in FIG. 9, the braking force (brake G) in the “enlarged region braking” and the “full-scale braking” is small as well as the startup timing of each stage. FIG. 9 show a second braking pattern corresponding to the first brake pattern selected at the time of no load shown in FIG. 3. Although each second braking pattern is prepared for the first braking pattern in FIG. 4 (at the time of half load) and FIG. 5 (at the time of specified load), only the second braking pattern to the first braking pattern in FIG. 3 (at the time of no load) will be described to facilitate understanding of the description. The same description is applied to the first braking pattern shown in FIG. 4 and FIG. 5.

The brake pattern selecting portion 40 of the brake control ECU 4 selects a first or second braking pattern corresponding to an operation input from the brake pattern change-over switch 14. Integration values of the first and second braking patterns are the same and brake forces on a final stage of the braking patterns are different.

That is, although the brake G of the “full-scale brake” is 0.5 G under the first braking pattern as shown in FIG. 8, the second braking pattern is 0.3 G. Because the integration values in the first and second braking patterns are equal, necessarily, the startup timing of the “warning” is earlier in the second braking pattern than in the first braking pattern (2.4 seconds to 3 seconds). Although in the first braking pattern, the startup timing of the “enlarged region braking” is 1.6 seconds and the brake G is 0.3 G, the startup timing in the second braking pattern is 2.5 seconds and the brake G is 0.2 G. Further, although the startup timing of the “full-scale braking” is 0.8 seconds in the first braking pattern, it is 1 second in the second braking pattern.

As evident from above, in the second braking pattern, deceleration of the speed is milder than in the first braking pattern. The vehicle driver can select a braking pattern corresponding to the type and weight of passengers or loaded cargo by recognizing a difference in the characteristic of the braking pattern. For example, if many aged persons or infants are included in the passengers or the loaded cargo is a precision machine or artifact, a braking pattern which induces a relatively mild deceleration may be selected. If the weight of the passengers or loaded cargo is large, the safety of the vehicle can be maintained high by selecting a braking pattern which induces a relatively milder deceleration as compared with a case where the weight is small.

When switching the braking pattern corresponding to the weight, it may be used interlockingly with the automatic change-over of the control pattern at the time of “no load”, “half load” and “specified load” shown in FIG. 3 to FIG. 5. That is, if the braking patterns shown in FIG. 3 to FIG. 5 is used together with the braking pattern shown in FIG. 9, the startup timing of each stage is earlier as compared with a case where they are not used at the same time and the braking force (brake G) in the “warning” and “enlarged region braking” is decreased. If the type of the cargo is fixed, it is permissible to adopt only the second braking pattern from the beginning without provision of the braking pattern change-over switch 14.

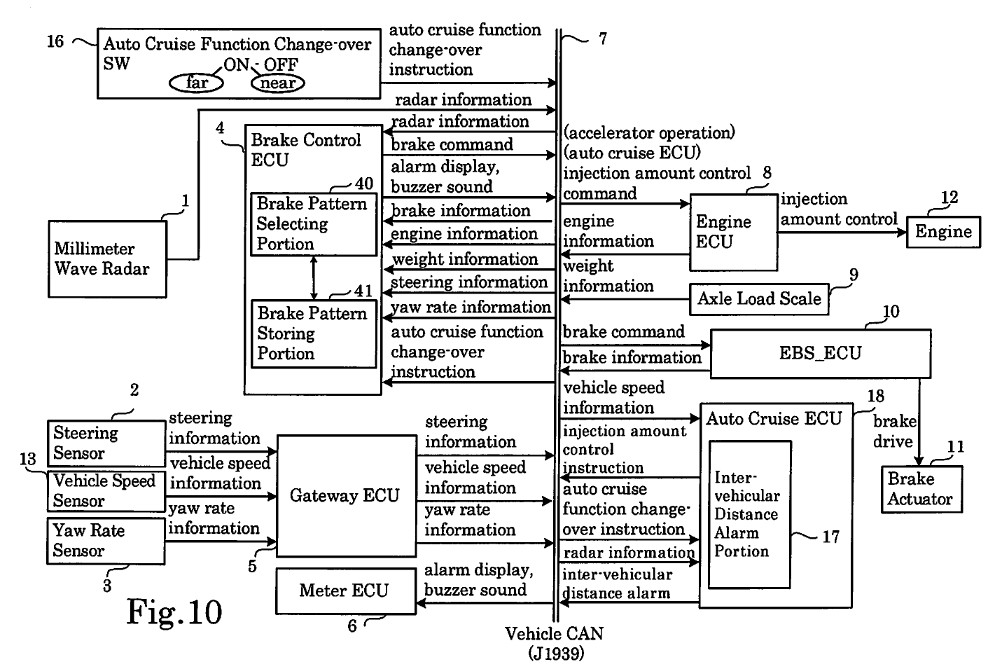

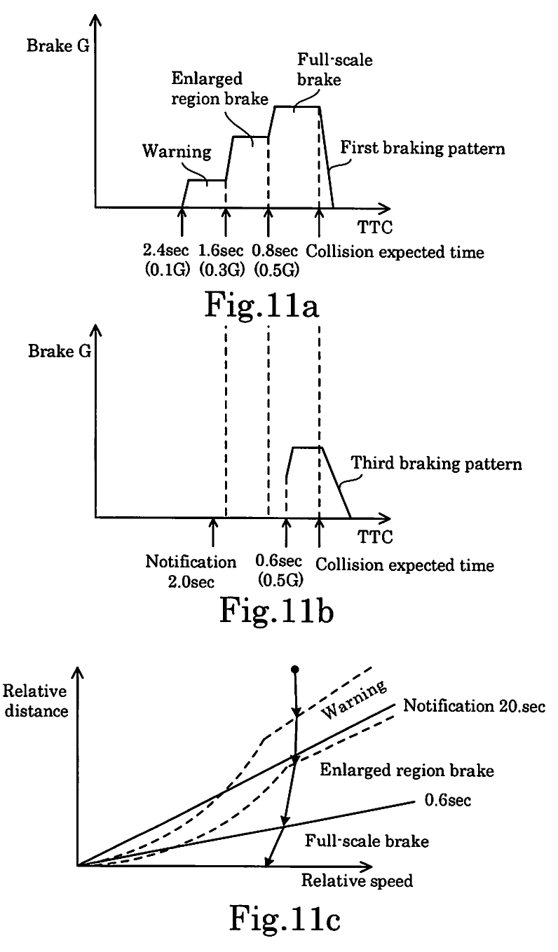

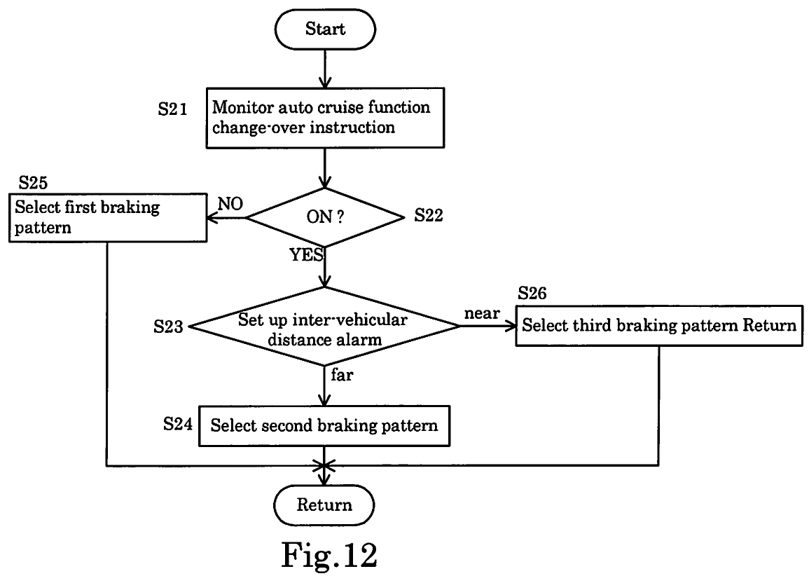

The third embodiment will be described with reference to FIG. 10 to FIG. 12. FIG. 10 is a configuration diagram of the control system of this embodiment. FIG. 11 are diagrams for comparing the first braking pattern with the third braking pattern. FIG. 12 is a flow chart showing the braking pattern selection procedure in the brake control ECU 4 of this embodiment.

As shown in FIG. 10, this embodiment includes an auto cruise ECU 18 and an inter-vehicular distance alarm portion 17 is included within the auto cruise ECU 18. If explaining the auto cruise function in a simple way, the auto cruise function is a function for automatically maintaining a specified speed set by operation input of a vehicle driver until a brake operation or acceleration operation is carried out. The auto cruise ECU 18 of this embodiment contains the inter-vehicular distance alarm portion 17 and this inter-vehicular distance alarm portion 17 dispatches an alarm to the vehicle driver if the distance to a leading vehicle traveling in front becomes smaller than a set distance during traveling with the auto cruise function ON, thereby urging the vehicle driver to release the auto cruise function or automatically turning off the auto cruise function.

Further, the inter-vehicular distance alarm portion 17 allows the vehicle driver to set up the length of the inter-vehicular distance which an alarm is dispatched using an auto cruise function change-over switch 16. According to this embodiment, the brake control ECU 4 changes over the braking pattern by this setting operation.

Radar information of the millimeter-wave radar 1 is input to the brake control ECU 4 and the auto cruise ECU 18, respectively. Alternatively, an auto cruise function change-over instruction from the auto cruise change-over switch 16 is input to the brake control ECU 4 and the auto cruise ECU 18. An inter-vehicular distance alarm from the auto cruise ECU 4 is displayed on a display portion (not shown) of the vehicle driver's seat through the meter ECU 6.

As shown in FIG. 11b and FIG. 11c, this embodiment contains a third braking pattern of notifying the vehicle driver of an alarm instead of executing the brake control on other stage than the “full-scale braking” of the final stage in the stepwise brake control. This third braking pattern is memorized in the brake pattern storing portion 41. In the example of FIG. 11b and FIG. 11c, notification is executed at a timing just before the “enlarged region braking” of the first braking pattern shown in FIG. 11a. The “full-scale braking” under the third braking pattern is started at about 0.6 seconds in TTC which is smaller than the “full-scale braking” of the first braking pattern.

As described above, the third braking pattern is a braking pattern which urges the vehicle driver to pay attention and is premised that the urged vehicle driver drives his or her vehicle for himself or herself and is based on a concept that the automatic brake control is an auxiliary means for the drive operation by the vehicle driver himself or herself.

Next, the braking pattern selection procedure of the brake control ECU 4 of this embodiment will be described with reference to FIG. 12. The brake pattern selecting portion 40 of the brake control ECU 4 monitors an auto cruise function change-over instruction performed using the auto cruise function change-over switch 16 as shown in FIG. 12 (S21) and if the auto cruise function is turned OFF (S22), the first braking pattern shown in FIG. 11a is selected (S25). If the auto cruise function is in ON state and the inter-vehicular distance setting is “near” (S23), it means that dependence on the inter-vehicular distance alarm portion 17 of the vehicle driver is low as described above. With that psychological state reflected upon selection of the braking pattern, only notification to the vehicle driver is executed on the “warning” and “enlarged region braking” in the first braking pattern and then, the third braking pattern of executing only the “full-scale braking” is selected (S26). On the contrary, if the auto cruise function is in ON state and the inter-vehicular distance setting is “far” (S23), it indicates that dependence upon the inter-vehicular distance alarm portion 17 of the vehicle driver is high and thus, with that psychological state reflected on selection of the braking pattern, for example, the second braking pattern described in FIG. 7 and FIG. 8 of the second embodiment is selected (S24). The second braking pattern is a braking pattern which automatically starts the brake control at an earlier stage in which TTC is longer than the first braking pattern and suitable for that psychological state.

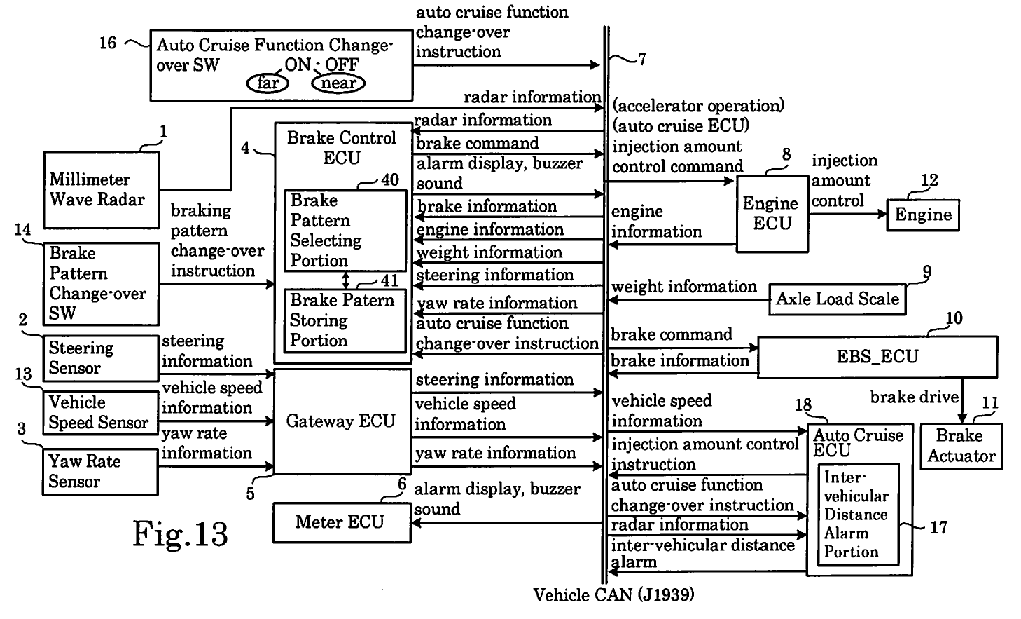

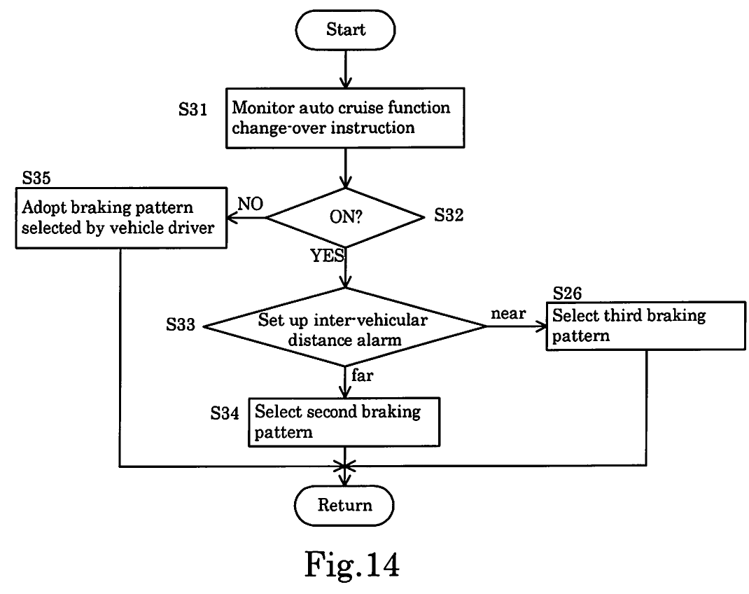

The fourth embodiment will be described with reference to FIG. 13 and FIG. 14. FIG. 13 is a configuration diagram of the control system of this embodiment. FIG. 14 is a flow chart showing the braking pattern selecting procedure in the brake control ECU 4 of this embodiment. This embodiment is an embodiment which adopts the second and third embodiments.

If explaining only a difference between this embodiment and the third embodiment, the brake pattern change-over switch 14 used in the second embodiment is added to the configuration of the control system of the third embodiment as shown in FIG. 13. Consequently, as shown in FIG. 14, a braking pattern selected by the vehicle driver using the brake pattern change-over switch 14 is selected when the auto cruise function is turned OFF (S35). The other operation is the same as the third embodiment. According to this embodiment, a braking pattern suitable for the psychological state of the vehicle driver is selected like the third embodiment and the vehicle driver can select a braking pattern corresponding to the type and weight of passengers or loaded cargo by recognizing a difference in characteristic of the braking pattern like the second embodiment.

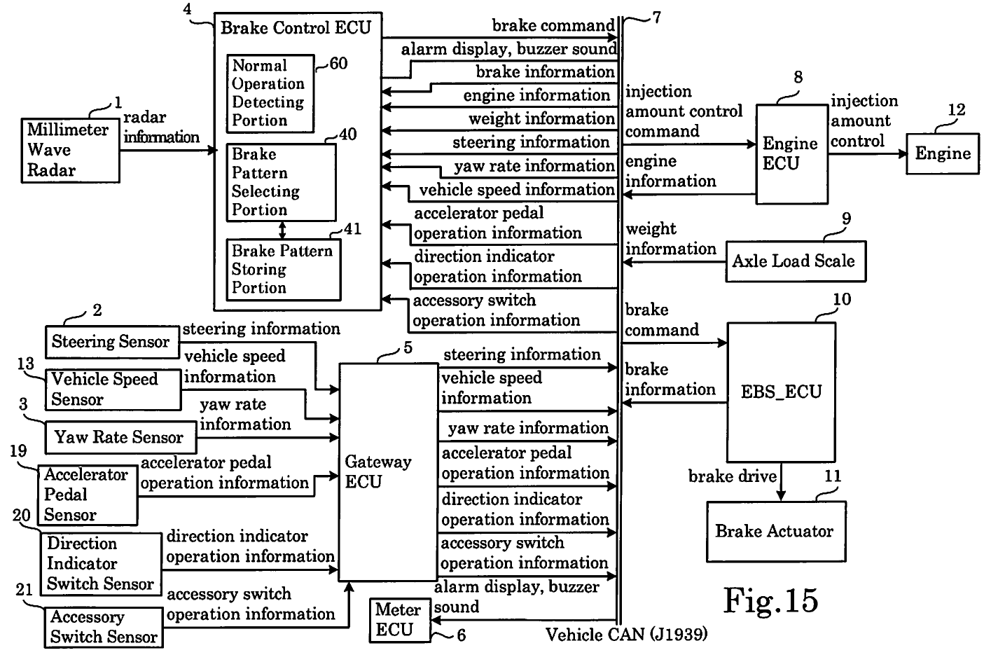

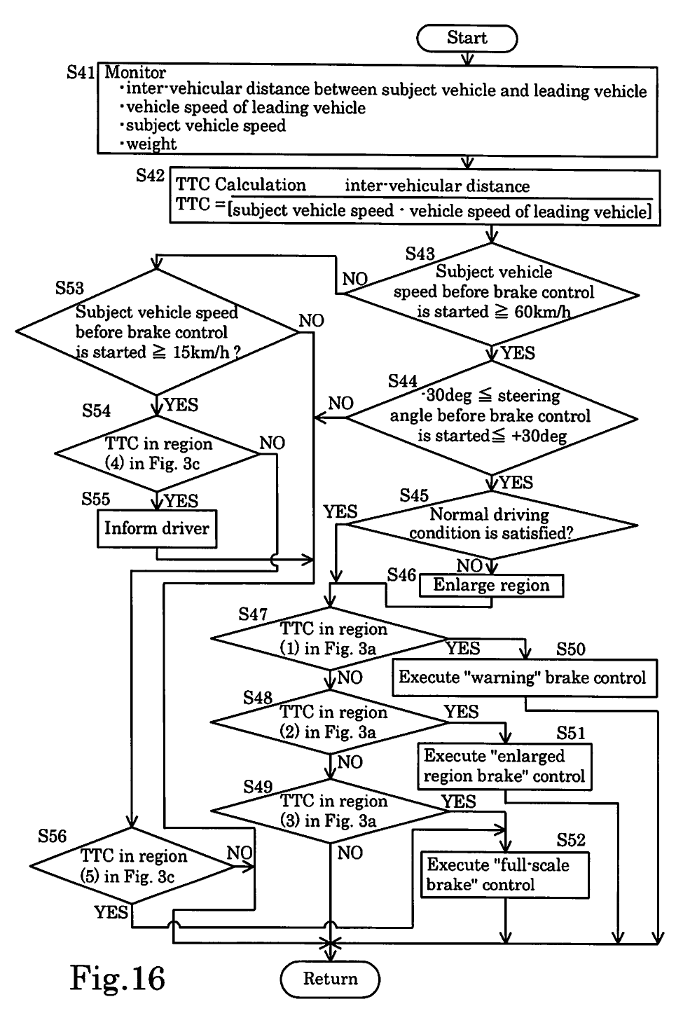

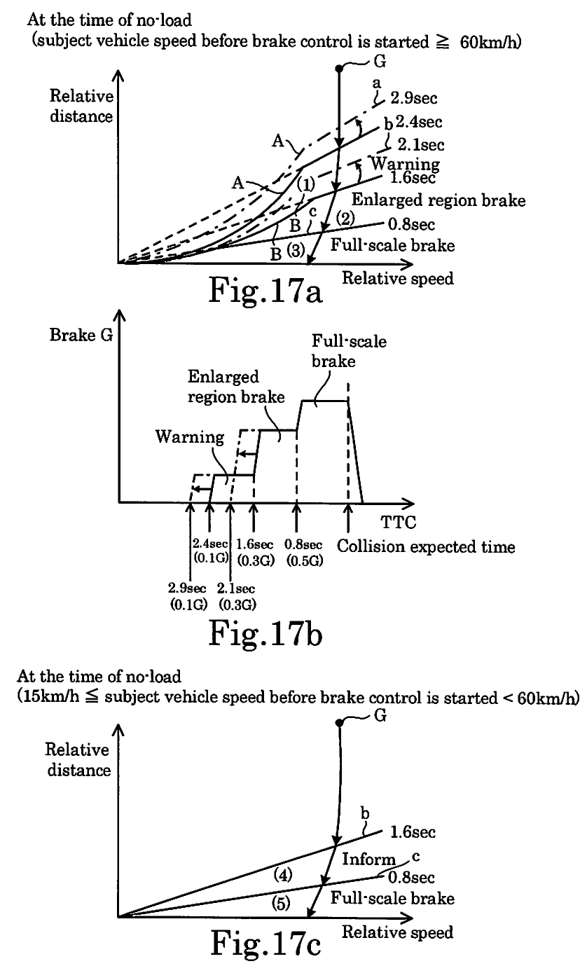

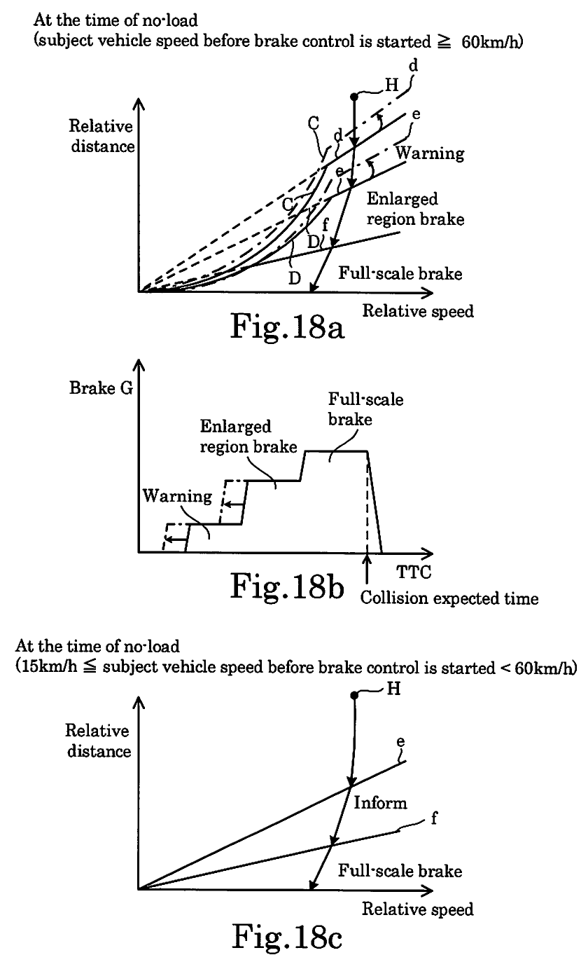

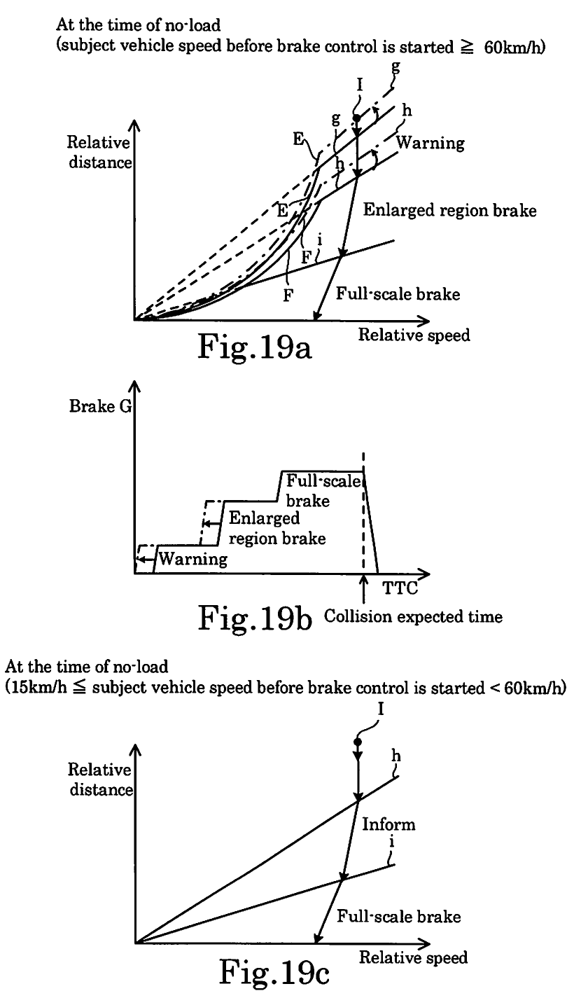

The automatic brake control device of the fifth embodiment will be described with reference to FIG. 15 to FIG. 19. FIG. 15 is a configuration diagram of the control system of this embodiment. FIG. 16 is a flow chart showing the operation of the brake control ECU of this embodiment. FIG. 17 are diagrams showing the braking pattern at the time of no load possessed by the brake control ECU of this embodiment. FIG. 18 are diagrams showing the braking pattern at the time of half load possessed by the brake control ECU of this embodiment. FIG. 19 are diagrams showing a braking pattern at the time of specified load possessed by the brake control ECU of this embodiment.

The configuration of the control system of this embodiment shown in FIG. 15 is the configuration of the control system of the first embodiment shown in FIG. 1 plus an accelerator pedal sensor 19, a direction indicator switch sensor 20 and an accessory switch sensor 21. Description concerning the configuration diagram of the control system of this embodiment which is a duplicate of the first embodiment is omitted.

As shown in FIG. 15, the accelerator pedal sensor 19, the direction indicator switch sensor 20, and the accessory switch sensor 21 are connected to the Vehicle CAN (J1939) 7 through the gateway ECU 5 and information of these sensors is fetched into the brake control ECU 4.

The feature of this embodiment exists in that if a detection result by the steering sensor 2, the vehicle speed sensor 13, the accelerator pedal sensor 19, the direction indicator switch sensor 20 and the accessory switch sensor 21 as a means for detecting an operation execution condition to the vehicle by the vehicle driver does not satisfy a condition which indicates the normality of driving by the vehicle driver, the brake control ECU 4 raises the set value of the TTC.

As for the condition indicating the normality of driving by the vehicle driver, unless the accessory switch sensor 21 detects an operation of the accessory switch by the vehicle driver, it can be estimated that the vehicle driver is driving normally concentrating his or her attention to the driving without operating any accessory device such as audio equipment or car navigation. Alternatively, if the accelerator pedal sensor 19 detects the operation of the accelerator pedal within a predetermined time (for example, 10 minutes), it can be estimated that the vehicle driver is driving normally without falling asleep. Or if a stoppage time of the vehicle is detected by the vehicle speed sensor 13 and the vehicle driver takes an appropriate rest time without continuous operation for a long hour, it can be estimated that the vehicle driver is driving normally. Additionally, it is permissible to detect a presence or absence of brake instruction from the vehicle driver.

According to this embodiment, logical sum of these detection results is obtained and when any detection result estimates a normal operation by the vehicle driver, it is estimated that the vehicle driver satisfies the normal driving condition. The above mentioned estimation and determination about whether or not the condition by the logical sum of the detection results is satisfied is carried out by a normal operation detection portion 60.

Next, an operation of the automatic brake control device of this embodiment will be described with reference to a flow chart of FIG. 16. FIG. 16 will be described about an example of the braking pattern at the time of no load (FIG. 17) and the braking patterns at the time of half load (FIG. 18) or specified load (FIG. 19) follow the procedure in the flow chart of FIG. 16. In the meantime, description of a duplicate of the flow chart of the first embodiment (FIG. 2) is omitted and mainly a procedure of step S45 and S46 will be described.

If the speed of a subject vehicle before the brake control is started is 60 km/h or more (S43), the steering angle before the brake control is started is +30 degrees or less and −30 degrees or more (S44), the vehicle driver satisfies the above described normal driving condition (S45) and the TTC is in a range (1) shown in FIG. 17a (S47), the “warning” brake control is executed (S50). If the TTC is a range (2) shown in FIG. 17a (S48), the “enlarged region brake” control is executed (S51). If the TTC is a range (3) shown in FIG. 17a, the “full-scale brake” control is executed (S52).

If the speed of the subject vehicle before the brake control is started is 60 km/h or more (S43), the steering angle before the brake control is started is +30 degrees or less and −30 degrees or more (S44), and the vehicle driver does not satisfy the above described normal driving condition (S45), the areas (1) and (2) indicated with a dot and dash line in FIG. 17b are expanded (S46) respectively. In the example of FIG. 17, the straight line a and the curve A having TTC of 2.4 seconds are advanced 0.5 seconds to obtain TTC of 2.9 seconds. Further, the straight line b and the curve B having TTC of 1.6 seconds are advanced 0.5 seconds to have TTC of 2.1 seconds. In the meantime, the “full-scale brake” area of FIG. 17a (3) is not expanded. Although in the examples of FIG. 17 to FIG. 19, the straight line and curve are advanced 0.5 seconds, the advanced range is 0.2 seconds to 0.5 seconds, respectively, which is set preliminarily from a vehicle braking characteristic measured by test driving or simulation.

The automatic brake control device of the sixth embodiment will be described with reference to FIG. 20. FIG. 20 is a flow chart showing the operation of the brake control ECU of this embodiment. The configuration of the control system of this embodiment is common to the fifth embodiment (FIG. 15).

The feature of this embodiment exists in that the brake control ECU 4 determines whether or not the condition indicating normality of the operation by the vehicle driver is satisfied with the normal operation detection portion 60 like the fifth embodiment and if this condition is satisfied, the quantity of steps in the automatic brake control is reduced.

When reducing the quantity of steps in the automatic brake control, the automatic brake control is started from the “full-scale brake” in the “warning”, “enlarged region brake” and “full-scale brake” shown in FIG. 3 to FIG. 5.

Next, the operation of the automatic brake control device of this embodiment will be described with reference to a flow chart of FIG. 20. Although FIG. 20 will be described about an example of the braking pattern at the time of no load (FIG. 3), those at the time of half load (FIG. 4) and at the time of specified load (FIG. 5) follow the procedure of the flow chart of FIG. 20. As shown in FIG. 20, an inter-vehicular distance to a leading vehicle traveling in front and the speed of the leading vehicle are measured and monitored with the millimeter-wave radar 1. Further, the vehicle speed of the subject vehicle is measured and monitored by the vehicle speed sensor 13. The weight of loaded cargo and passengers is measured and monitored by the axial load scale 9 (S61). The brake pattern selecting portion 40 of the brake control ECU 4 previously selects any braking pattern (FIG. 3 to FIG. 5) based on a result of measurement of the weight. A description below shows an example that the brake control pattern of FIG. 3 is selected.

TTC is computed according to the inter-vehicular distance, the speed of a subject vehicle and the speed of a leading vehicle (S62). The computation method is as described previously. If the speed of the subject vehicle before the brake control is started is 60 km/h or more (S63), the steering angle before the brake control is started is +30 degrees or less and −30 degrees or more (S64) and it is determined that the condition indicating normality of the operation by the vehicle driver is not satisfied by the normal operation detection portion 60 (S65), when TTC is in a range (1) shown in FIG. 3a (S66), the “enlarged region brake” control is executed (S70). If TTC is a range (3) shown in FIG. 3a (S68), the “full-scale brake” control is executed (S71). If it is determined that the condition indicating the normality of the vehicle driver is satisfied by the normal operation detection portion 60 (S65), when TTC is a range (3) shown in FIG. 3a (S68), the “full-scale brake” control is executed (S71).

If the speed of a subject vehicle before the brake control is started is less than 60 km/h to 15 km/h or more (S63 and S72) and TTC is a range (4) shown in FIG. 3c (S73), it is notified a vehicle driver that the relative distance to the leading vehicle is small (S74). The notification is carried out by alarm display and buzzer sound. Further, if TTC is a range (5) shown in FIG. 3c (S75), the “full-scale brake” control is executed (S71).

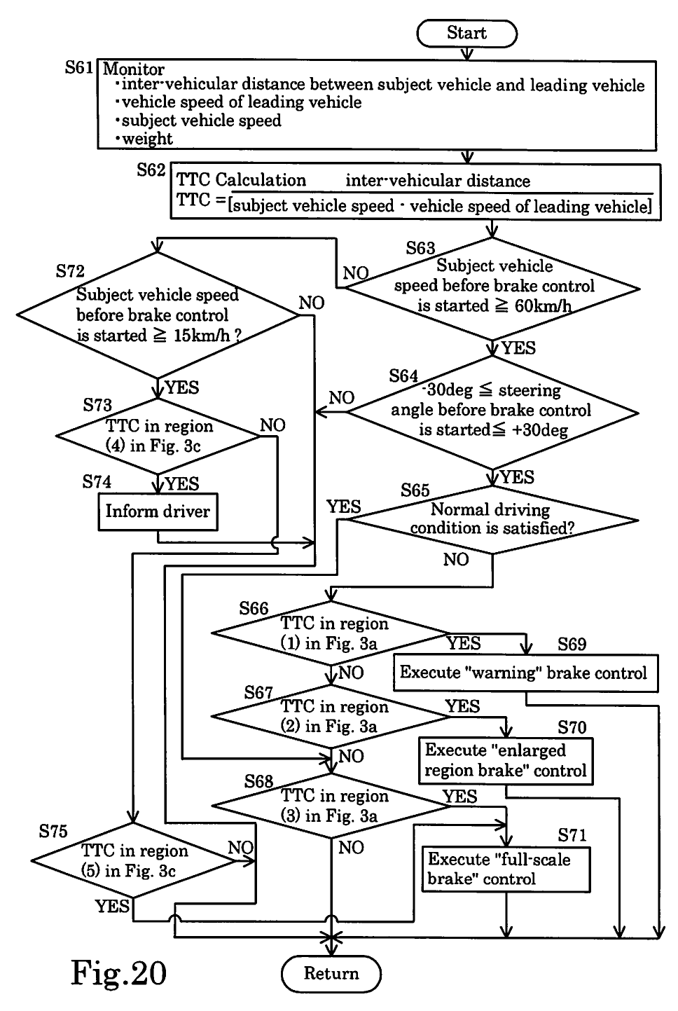

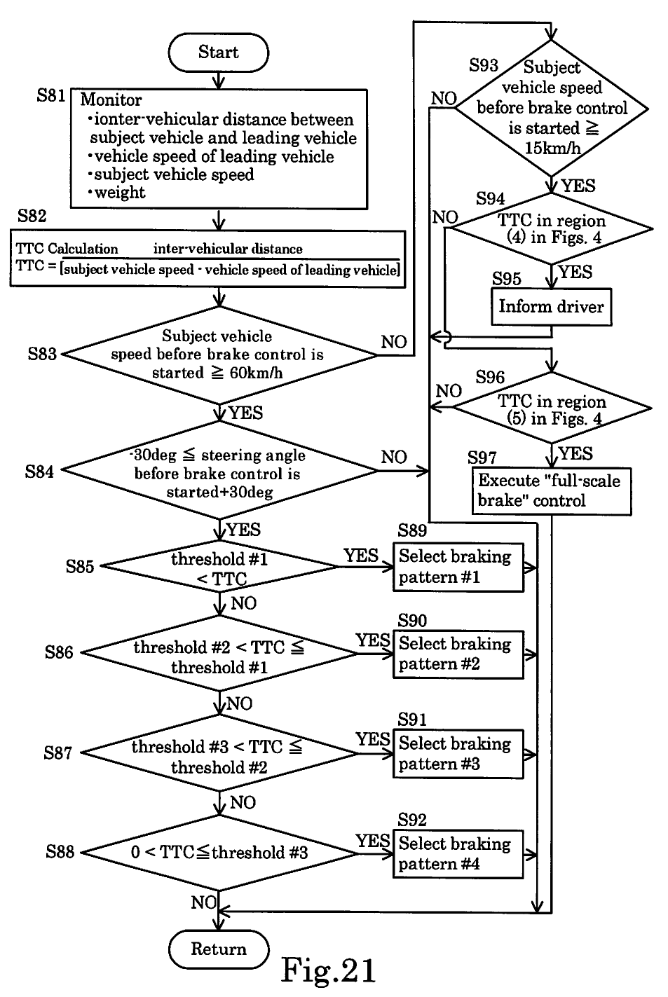

In the meantime, the yaw rate from the yaw rate sensor 3 may be used instead of the steering angle from the steering sensor 2. Alternatively, the steering angle and the yaw rate may be used at the same time. The automatic brake control device of the seventh embodiment will be described with reference to FIG. 21 to FIG. 26. The configuration diagram of the control system of this embodiment is common to the first embodiment (FIG. 1). FIG. 21 is a flow chart showing the operation of the brake control ECU of this embodiment. FIG. 22 is a flow chart showing the operation procedure of the brake pattern at the time of no load of this embodiment.

The feature of this embodiment exists in that the brake control ECU 4 changes the braking pattern corresponding to TTC.

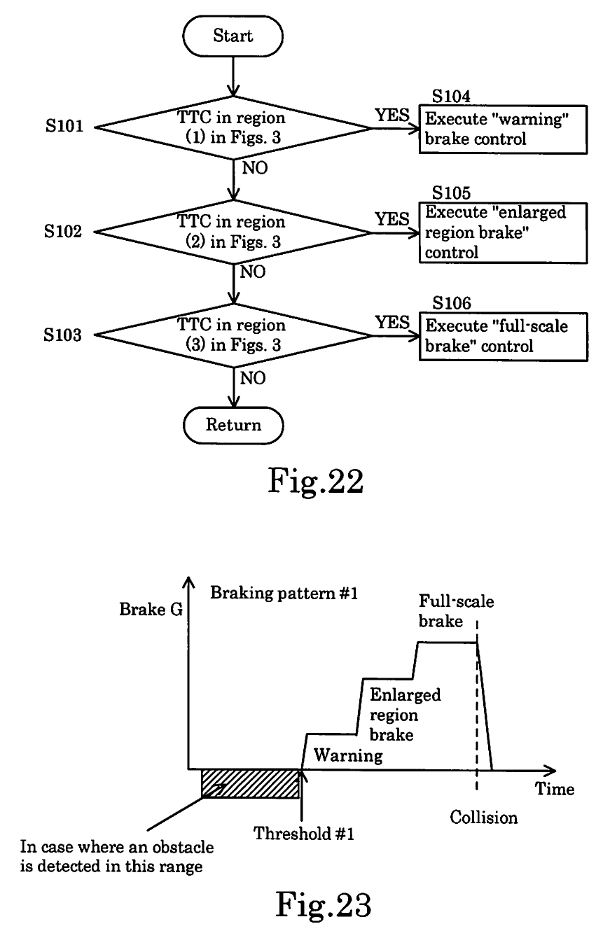

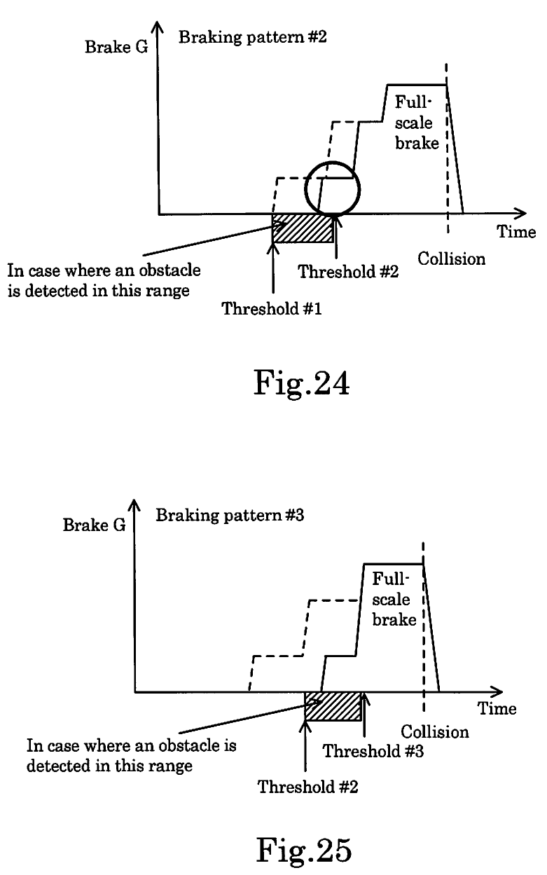

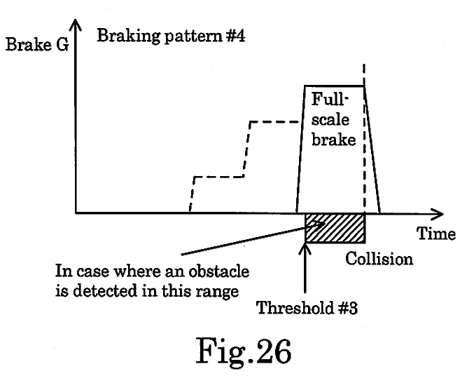

FIG. 23 to FIG. 26 are diagrams for explaining braking patterns #1 to #4 corresponding to the TTC. To reduce the quantity of steps for changing the braking pattern, the brake control ECU 4 changes the shape (for example, FIG. 3) of a braking pattern applied when the quantity of steps is not reduced to new braking patterns #3 and #4 corresponding to the quantity of reduced steps as shown in FIG. 25 and FIG. 26. Alternatively, only the braking pattern shape can be changed without reduction of the quantity of steps like the braking patterns #1 and #2 shown in FIG. 23 and FIG. 24.

As for the means for changing to new braking patterns #1 to #4, the braking patterns #1 to #4 corresponding to each of the braking patterns shown in FIG. 3 (at the time of no load), FIG. 4 (at the time of half load) and FIG. 5 (at the time of specified load) are memorized in the brake pattern storing portion 41 and the brake pattern selecting portion 40 selects an appropriate (or similar) braking pattern from these braking patterns corresponding to the value of the TTC so as to change the braking patterns shown in FIG. 3, FIG. 4 and FIG. 5 to the braking patterns #1 to #4 shown in FIG. 23 to FIG. 26.

Next, the operation of the automatic brake control device of this embodiment will be described with reference to a flow chart of FIG. 21. Although FIG. 21 will be described about an example of a braking pattern at the time of no load (FIG. 3), the braking pattern at the time of half load (FIG. 4) or at the time of specified load (FIG. 5) follows the procedure of the flow chart of FIG. 21. As shown in FIG. 21, the inter-vehicular distance to a leading vehicle and the speed of the leading vehicle are measured and monitored by the millimeter-wave radar 1. Further, the speed of the subject vehicle is measured and monitored by the vehicle speed sensor 13. The weight of loaded cargo and passengers is measured and monitored by the axial load scale 9 (S81). The brake pattern selecting portion 40 of the brake control ECU 4 previously selects any braking pattern (FIG. 3, FIG. 4, and FIG. 5) based on a result of measurement of the weight. A description below shows an example that the brake control pattern of FIG. 3 is selected.

TTC is computed according to the inter-vehicular distance, the speed of a subject vehicle and the speed of a leading vehicle (S82). The computation method is as described previously. If the speed of the subject vehicle before the brake control is started is 60 km/h or more (S83), and the steering angle before the brake control is started is +30 degrees or less and −30 degrees or more (S84), when the value of TTC computed by step S62 is larger than a threshold #1 (S85), the braking pattern #1 shown in FIG. 23 is selected. The shape of the braking pattern #1 is the same as the shape of the braking pattern shown in FIG. 3b. The threshold #1 is 2.4 seconds in the example of FIG. 3b.

If the value of the TTC computed in steps S82 is larger than a threshold #2 and the threshold #1 or less (S86), a braking pattern #2 shown in FIG. 24 is selected. The shape of the braking pattern #2 is obtained by changing the shape of the braking pattern shown in FIG. 3b. The shape of the braking pattern before changed is indicated with a dotted line. Although the braking pattern having these stages is maintained, the ranges of the warning and the enlarged region brake are reduced in this braking pattern. The threshold #2 is set near 1.6 seconds in the example of FIG. 3b. Consequently, the changes in braking pattern are milder as compared with a case of reducing the quantity of steps, thereby maintaining the stability of the vehicle high.

If the value of the TTC computed in step S82 is larger than a threshold #3 and the threshold #2 or less (S87), a braking pattern #3 shown in FIG. 25 is selected. The shape of the braking pattern #3 is obtained by changing the shape of the braking pattern shown in FIG. 3b. The shape of the braking pattern before changed is indicated with a dotted line. If comparing with the shape of the braking pattern shown in FIG. 3b, there is no enlarged region brake and the full-scale brake is initiated just after the alarm is dispatched. The threshold #3 is set near 0.8 seconds in the example of FIG. 3b.

If the value of the TTC computed in step S82 is smaller than the threshold #3 (S88), a braking pattern #4 shown in FIG. 26 is selected. The shape of the braking pattern #4 is obtained by changing the shape of the braking pattern shown in FIG. 3b. The shape of the braking pattern before changed is indicated with a dotted line. If comparing with the shape of the braking pattern shown in FIG. 3b, there is provided only the full-scale brake.

Although the stepwise brake control is carried out if possible corresponding to the value of the TTC, if the value of the TTC is extremely small, the quick brake can be executed all at once. Consequently, appropriate automatic brake control can be carried out corresponding to the value of the TTC.

If the speed of a subject vehicle before the brake control is started is 60 km/h or less to 15 km/h or more (S83 and S93) and TTC is a range (4) shown in FIG. 3c (S94), it is notified that a vehicle driver the relative distance to the leading vehicle is small (S95). The notification is carried out by alarm display and buzzer sound. Further, if TTC is a range (5) shown in FIG. 3c (S96), the “full-scale brake” control is executed (S97).

In the meantime, the yaw rate from the yaw rate sensor 3 may be used instead of the steering angle from the steering sensor 2. Alternatively, the steering angle and the yaw rate may be used at the same time.

According to the braking pattern shown in FIG. 3, as shown in FIG. 22, the “warning” brake control is executed (S104) if the TTC is in the range (1) shown in FIG. 3a (S101). If the TTC is in the range (2) shown in FIG. 3a, the “enlarged region brake” control is executed (S105). If the TTC is in the range (3) shown in FIG. 3a (S103), the “full-scale brake” control is executed (S106). The respective braking patterns shown in FIG. 4 and FIG. 5 follow this.

### INDUSTRIAL APPLICABILITY

The present invention enables the automatic brake control of truck and bus to be executed appropriately corresponding to changes in the weight of loaded cargo and passengers. Alternatively, it can be executed corresponding to the driving condition of the vehicle driver, thereby contributing to traffic safety. Further, the appropriate brake control is possible in case where the TTC is very small, thereby a wide range of unexpected phenomena being met.

1. An automatic brake control device comprising a control means which automatically executes brake control based on a sensor output containing a distance to an object existing in an advancing direction of a subject vehicle even if any drive operation is not performed, the control means including a stepwise brake control means which automatically performs stepwise brake control when an estimated value of a time elapsed until a distance between the object and the subject vehicle computed based on a relative distance and a relative speed between the object and the subject vehicle obtained by the sensor output becomes smaller than a predetermined distance, wherein the stepwise brake control means contains a means for changing the braking pattern corresponding to the weight of loaded cargo or passengers.

2. An automatic brake control device comprising a control means which automatically executes brake control based on a sensor output containing a distance to an object existing in an advancing direction of a subject vehicle even if any drive operation is not performed, the control means including a stepwise brake control means which automatically performs stepwise brake control of increasing a braking force or a braking decelerating speed gradually through plural stages when an estimated value of a time elapsed until a distance between the object and the subject vehicle computed based on a relative distance and a relative speed between the object and the subject vehicle obtained by the sensor output becomes smaller than a predetermined distance, wherein different plural braking patterns for executing the stepwise brake control are provided and the stepwise brake control means includes a means for selecting any of the plural braking patterns corresponding to an operation input.

3. The automatic brake control device according to claim 2 wherein the integration values of the different plural braking patterns are equal while the braking force or brake decelerating speed on a final stage of each braking pattern is different.

4. The automatic brake control device according to claim 2 wherein the braking pattern contains a pattern of notifying a vehicle driver of an alarm instead of the brake control on other stages than the final stage in the stepwise brake control.

5. The automatic brake control device according to claim 2 further comprising an inter-vehicular distance alarm means for dispatching an alarm corresponding to an inter-vehicular distance between a leading vehicle and a subject vehicle, wherein the inter-vehicular distance alarm means is provided with a means for setting the inter-vehicular distance which dispatches the alarm by operation of the vehicle driver and the operation input is interlocked with setting operation of the setting means.

6. An automatic brake control device comprising a control means which automatically executes brake control based on a sensor output containing a distance to an object existing in an advancing direction of a subject vehicle even if any drive operation is not performed, the control means including a stepwise brake control means which automatically performs stepwise brake control when an estimated value of a time elapsed until a distance between the object and the subject vehicle computed based on a relative distance and a relative speed between the object and the subject vehicle obtained by the sensor output becomes smaller than a predetermined distance, wherein
the stepwise brake control means is an automatic brake control device containing a brake control means for increasing the braking force or brake decelerating speed gradually in times series through plural stages and comprising: a means for detecting an operation execution condition to the vehicle by the vehicle driver; and a means for raising the set value unless the result of detection by the detecting means satisfies a condition indicating normality of operation by the vehicle driver.

7. An automatic brake control device comprising a control means which automatically executes brake control based on a sensor output containing a distance to an object existing in an advancing direction of a subject vehicle even if any drive operation is not performed, the control means including a stepwise brake control means which automatically performs stepwise brake control when an estimated value of a time elapsed until a distance between the object and the subject vehicle computed based on a relative distance and a relative speed between the object and the subject vehicle obtained by the sensor output becomes smaller than a predetermined distance, wherein
the stepwise brake control means is an automatic brake control device containing a brake control means for increasing the braking force or brake decelerating speed gradually in times series through plural stages and comprising: a means for detecting an operation execution condition to the vehicle by the vehicle driver; and a means for reducing the quantity of stages if the result of detection by the detecting means satisfies normality of operation by the vehicle driver.

8. The automatic brake control device according to claim 7 wherein the reducing means comprises a means for starting the automatic brake control from the final stage of the plural stages.

9. An automatic brake control device comprising a control means which automatically executes brake control based on a sensor output containing a distance to an object existing in an advancing direction of a subject vehicle even if any drive operation is not performed, the control means including a stepwise brake control means which automatically performs stepwise brake control when an estimated value of a time elapsed until a distance between the object and the subject vehicle computed based on a relative distance and a relative speed between the object and the subject vehicle obtained by the sensor output becomes smaller than a predetermined distance, wherein
the stepwise brake control means contains a brake control means for increasing the braking force or brake decelerating speed gradually in times series through plural stages and the brake control means has a means for changing the braking pattern corresponding to the estimated value.

10. The automatic brake control device according to claim 9 wherein the means for changing the braking pattern comprises a means for reducing the quantity of the stages.

11. The automatic brake control device according to claim 10 wherein the means for reducing the quantity of the stages contains a means for changing the shape of a braking pattern applied if the quantity of the stages is not reduced to the shape of a new braking pattern corresponding to the reduced quantity of the stages.

12. The automatic brake control device according to claim 9 wherein the means for changing the braking pattern comprises a means for changing the shape of the braking pattern without reducing the quantity of the stages.

13. The automatic brake control device according to claim 1 further comprising a means for if the speed of a subject vehicle is less than a predetermined value and the steering angle or the yaw rate is out of a predetermined range, prohibiting startup of the stepwise brake control means.
